(19) United States
(12) Patent Application Publication
(10) Pub. No.: US 2026/0352330 A1
(43) Pub. Date: Nov. 5, 2026

(54) COMMUNICATION SYSTEM AND CONTROL METHOD

(71) Applicant: NTT, Inc., Tokyo (JP)

(72) Inventors: Manabu YOSHINO, Musashino-shi, Tokyo (JP); Shin KANEKO, Musashino-shi, Tokyo (JP); Kazutaka HARA, Musashino-shi, Tokyo (JP); Junichi KANI, Musashino-shi, Tokyo (JP); Naotaka SHIBATA, Musashino-shi, Tokyo (JP)

(21) Appl. No.: 19/109,168

(22) PCT Filed: Sep. 7, 2022
(86) PCT No.: PCT/JP2022/033554

§ 371 Date: Mar. 6, 2025

(51) Int. Cl. H04Q 11/00

(52) U.S. Cl. CPC H04Q 11/0005; H04Q 2011/0009; H04Q 2011/0033; H04Q 2213/003

(57) ABSTRACT

An aspect of the present invention includes: an acquirer that acquires a wavelength set to a user terminal; an optical cross-connect that outputs an optical signal to at least one output destination of a plurality of output destinations; an observer that observes a wavelength of a signal output from a user terminal to the optical cross-connect or a wavelength of a signal output from the optical cross-connect to a user terminal; and a blocker that blocks communication with the user terminal, or blocks a wavelength component of an observed wavelength, in a case where a wavelength observed by the observer is different from a wavelength acquired by the acquirer.

### TECHNICAL FIELD

The present invention relates to a technology of a communication system, and a control method.

### BACKGROUND ART

There is an innovative optical and wireless network (IOWN) that eliminates photoelectric conversion and electrical routing processing as much as possible. A user device in an all-photonics network (APN) of the IOWN illustrated in FIG. 19 performs communication using a wavelength and a route that are set to a photonic gateway (Ph-GW). The wavelength and the route set by the Ph-GW may be designated by, for example, an APN controller.

Exchange of a wavelength and route information is performed using, for example, a control signal channel said to be auxiliary management and control channel (AMCC) at the start of communication of the user device. At the start of communication, the user device communicates with a control functioner disposed in the Ph-GW and is connected to any communication destination.

The Ph-GW includes five functions. The first is a wavelength control/monitoring function of designating and controlling which wavelength is used by a user device and monitoring the wavelength of a signal. The second is a passing/stopping function of passing a signal in accordance with opening of a path and stopping an unnecessary signal. The third is a aggregation/disaggregation function of a function of aggregating optical signals having wavelengths set to respective user devices as necessary and transferring the optical signals to a relay network, and disaggregating optical signals transferred from the relay network for each of the wavelengths as necessary and transferring the optical signals to the user devices. The fourth is a turning function of enabling turning back at the Ph-GW to which an optical signal is input without transferring the optical signal to the relay network. The fifth is an extraction/insertion function for performing reproduction, relay, and electrical processing.

The Ph-GW can be regarded as a reconfigurable optical add-drop multiplexer (ROADM) including a function of controlling a remote transponder (TPND) and not including the TPND in itself, or a TPND aggregator (TPA, transponder aggregation switch) included in a ROADM including a function of controlling a remote TPND and not including the TPND in itself. Four structural examples of a ROADM will be described.

FIG. 20 is a diagram illustrating Configuration Example 1 of a ROADM or a part thereof. Configuration Example 1 includes an M*1 WSS 9012 having an M*1 configuration, a 1*N coupler/splitter 9021 having a 1*N configuration, an N*1 WSS 9010 having an N*1 configuration, and a 1*M WSS 9011 having a 1*M configuration. Note that a WSS is a wavelength selective switch.

The M*1 WSS 9012 receives as input signals on M paths from a user network interface (hereinafter, referred to as “UNI”) side. The M*1 WSS 9012 multiplexes the signals input from the UNI side according to the combination of an input port and a wavelength, and outputs the signals to the 1*N coupler/splitter 9021. The coupler/splitter 9021 splits the signals input from the M*1 WSS 9012 for N paths, and outputs the signals to the N paths on a network network interface (hereinafter, referred to as “NNI”) side.

The N*1 WSS 9010 receives as input signals on N paths from the NNI side. The N*1 WSS 9010 multiplexes the signals input from the NNI side according to the combination of an input port and a wavelength, and outputs the signals to the 1*M WSS 9011. The 1*M WSS 9011 outputs the signals from the N*1 WSS 9010 to M paths on the UNI side according to the wavelength.

Configuration Example 1 includes a Colorless function and a Directionless function, but does not include a Contentionless function. The Colorless function is a function of changing a combination of a wavelength (=Color) and a port such that a signal route inside a node is not restricted by a wavelength of a signal by providing a wavelength tunable function to a multiplexing-demultiplexing filter or the like. The Directionless function is a function of freely setting the direction of input/output paths of a transponder by a transponder aggregation switch configuration or the like in which two WSSs are connected so as to face each other. The Contentionless function is a function of avoiding collision of signals having the same wavelength inside a transponder aggregation switch connected to different paths by a WSS having an N*M configuration or the like in which a plurality of ports is included in each of input and output and any path is set among the plurality of ports.

FIG. 21 is a diagram illustrating Configuration Example 2. Configuration 2 is a configuration using two upper and lower multicast switches (MCSs). The first MCS of Configuration Example 2 includes M 1*N optical switches 9113 and N M*1 couplers/splitters 9111, and the other MCS includes N 1*M couplers/splitters 9112 and M N
1 optical switches 9114. In the first MCS, each of the 1
N optical switches 9113 receives as input a signal on one path from the UNI side. Each of the 1*N optical switches 9113 outputs the signal input from the UNI side to any of the M*1 couplers/splitters 9111. Each of the M*1 couplers/splitters 9111 multiplexes signals input from the 1*N optical switches 9113 and outputs the multiplexed signals to one path on the NNI side.

In the other MCS, each of the 1*M couplers/splitters 9112 receives as input a signal on one path from the NNI side. Each of the 1*M couplers/splitters 9112 splits the signal input from the NNI side and outputs the signals to the N*1 optical switches 9114. Each of the N*1 optical switches 9114 selects a signal from the 1*M couplers/splitters 9112 according to the input port, and outputs the signal to one path on the UNI side. Configuration Example 2 includes the Colorless function, the Directionless function, and the Contentionless function. In Configuration Example 2, an amplifier for compensating for losses of the MCSs due to the splitting is usually required.

FIG. 22 is a diagram illustrating Configuration Example 3. Configuration Example 3 includes an M*N WSS 9201 and an N*M WSS 9202. The M*N WSS 9201 receives as input signals on M paths from the UNI side. The M*N WSS 9201 outputs the signals input from the UNI side to any of N paths on the NNI side according to the combination of an input port and a wavelength. The N*M WSS 9202 receives as input signals on the N paths from the NNI side. The N*M WSS 9202 outputs the signals input from the NNI side to any of M paths on the UNI side according to the combination of an input port and a wavelength. Configuration Example 3 includes the Colorless function, the Directionless function, and the Contentionless function.

FIG. 23 is a diagram illustrating Configuration Example 4. Configuration Example 4 includes an M*N optical switch 9302, arrayed-waveguide gratings (AWGs) 9303, AWGs 9313, and an N*M optical switch 9312. The M*N optical switch 9302 receives as input signals on M paths from the UNI side. The M*N optical switch 9302 outputs the signals input from the UNI side to any port of any AWG 9303 according to the input port. Each of the AWGs 9303 multiplexes the signals input from the M*N optical switch 9302 according to the combination of an input port and a wavelength, and outputs the signals to the NNI side. Each of the AWGs 9313 outputs a signal input from the NNI side to any of N ports of the N*M optical switch 9312 according to the combination of an input port and a wavelength. The N*M optical switch 9312 outputs signals input from the AWGs 9313 to M paths on the UNI side according to the input port.

The Ph-GW can be configured using each of the above-described Configuration Examples 1 to 4 or a part thereof. The Ph-GW can be configured using a component having no wavelength selectivity such as an MCS.

### CITATION LIST

### Non Patent Literature

Non Patent Literature 1:“Novel System Architecture toward the Realization of All-photonics Network”, the Journal of Institute of Electronics, Information and Communication Engineers Vol. 104 No. 5pp. 471-477, 2021
Non Patent Literature 2: The Structures of ROADMhttps://optical-passive.com/2019/08/30/the-structures-of-roadm/

### SUMMARY OF INVENTION

### Technical Problem

In a Ph-GW, if a user terminal uses only a wavelength set by an APN controller, a signal needs to be transmitted, and if an unset inappropriate wavelength is used, a signal needs to be blocked. However, in configurations other than Configuration Example 4 that are a part of the configuration examples described above, there is an issue that a signal having an inappropriate wavelength cannot be blocked.

In view of the above circumstances, an object of the present invention is to provide a technology for blocking a signal having an inappropriate wavelength.

### Solution to Problem

An aspect of the present invention is a communication system including: an acquirer that acquires a wavelength set to a user terminal; an optical cross-connect that outputs an optical signal to at least one output destination of a plurality of output destinations; an observer that observes a wavelength of a signal input from a user terminal to the optical cross-connect or a wavelength of a signal output from the optical cross-connect to a user terminal; and a blocker that blocks input from the user terminal or output to a user terminal, or blocks a wavelength component different from an acquired wavelength, in a case where a wavelength observed by the observer is different from a wavelength acquired by the acquirer.

An aspect of the present invention is a control method of a communication system including an optical cross-connect that outputs an optical signal to at least one output destination of a plurality of output destinations, the control method including: an acquisition step of acquiring a wavelength set to a user terminal; an observation step of observing a wavelength of a signal input from a user terminal to the optical cross-connect or a wavelength of a signal output from the optical cross-connect to a user terminal; and a blocking step of blocking input from the user terminal or output to a user terminal, or blocking a wavelength component different from an acquired wavelength, in a case where a wavelength observed in the observation step is different from a wavelength acquired in the acquisition step.

### Advantageous Effects of Invention

According to the present invention, it is possible to provide a technology for reducing conduction of a signal having an inappropriate wavelength.

### BRIEF DESCRIPTION OF DRAWINGS

FIG. 1 is a configuration diagram illustrating a communication system according to the present embodiment.

FIG. 2 is a diagram illustrating a configuration example of a Ph-GW according to a first embodiment.

FIG. 3 is a diagram illustrating an alternative configuration of an SA.

FIG. 4 is a diagram illustrating a configuration example of a Ph-GW according to a second embodiment.

FIG. 5 is a diagram illustrating a configuration example of a Ph-GW according to a third embodiment.

FIG. 6 is a diagram illustrating a configuration example of a Ph-GW according to a fourth embodiment.

FIG. 7 is a diagram illustrating a configuration example of a Ph-GW according to a fifth embodiment.

FIG. 8 is a diagram illustrating a configuration example of a Ph-GW according to a sixth embodiment.

FIG. 9 is a diagram illustrating a configuration example of a Ph-GW according to a seventh embodiment.

FIG. 10 is a diagram illustrating a configuration example of a Ph-GW according to an eighth embodiment.

FIG. 11 is a flowchart illustrating a flow of processing common in each embodiment.

FIG. 12 is a diagram illustrating a configuration example in which a separator 21 is configured using a fiber bragg grating (FBG).

FIG. 13 is a diagram illustrating a configuration example in which the separator 21 is configured using a thin film filter (TFF).

FIG. 14 is a diagram illustrating a configuration example in which the separator 21 is configured using an arrayed-waveguide grating (AWG).

FIG. 15 is a diagram illustrating a configuration example of the separator 21 configured using a modification of the AWG.

FIG. 16 is a diagram illustrating a specific example of the separator 21 configured using a reflection type diffraction grating.

FIG. 17 is a diagram illustrating a configuration example in which the separator 21 is configured using a waveguide-type ring resonator.

FIG. 18 is a diagram illustrating a configuration example in which the separator 21 is configured using a lattice-type optical filter.

FIG. 19 is a diagram illustrating user device at an APN.

FIG. 20 is a diagram illustrating Configuration Example 1 of a ROADM.

FIG. 21 is a diagram illustrating Configuration Example 2 of the ROADM.

FIG. 22 is a diagram illustrating Configuration Example 3 of the ROADM.

FIG. 23 is a diagram illustrating Configuration Example 4 of the ROADM.

### DESCRIPTION OF EMBODIMENTS

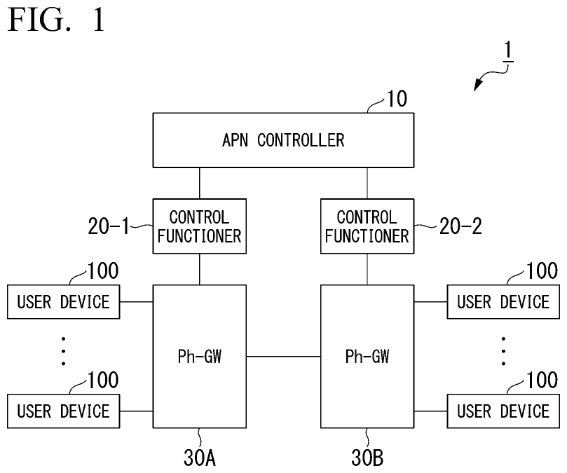

FIG. 1 is a configuration diagram illustrating a communication system 1 according to the present embodiment. The communication system 1 includes an all-photonics network (APN) controller (also referred to as “APNC”) 10, control functioners 20-1 and 20-2, Ph-GWs 30-1 and 30-2, and user devices 100. In a case where each of the control functioners 20-1 and 20-2 is not distinguished, they are referred to as control functioner 20. The control functioner 20 controls the Ph-GW autonomously or according to an instruction or the like from the APNC 10, and sets a route of the Ph-GW. The Ph-GW controls user devices autonomously or according to an instruction or the like from the control functioner 20 or the APNC 10. For example, the transmission/reception wavelength is controlled. The control functioner 20 or the APNC 10 may directly control the user devices 100. In that case, the control functioner 20 or the APNC 10 may include an AMCC transceiver in a case where an AMCC is used as the control signal, for example, in order to transmit and receive a control signal to and from the user devices 100. In a case where each of the Ph-GWs 30-1 and 30-2 is not distinguished, they are referred to as Ph-GW 30.

Each of the user devices 100 is connected to the Ph-GW 30. Each of the user devices 100 exchanges information with the Ph-GW 30 via the control functioner 20, for example. At this time, the control functioner may be a part of the Ph-GW 30.

The Ph-GW 30 is connected to the control functioner 20. Note that, in a case where the control functioner 20 is a part of the Ph-GW 30, each of the user devices 100 may be connected to the Ph-GW 30 so as to be able to communicate also with the control functioner 20. In the configuration illustrated in FIG. 1, each of the user devices 100 sets a wavelength or the like used for communication by exchanging a control signal for performing management control of communication with the Ph-GW using a control signal, for example, a control signal on the AMCC at the start of communication. At the time of setting, the Ph-GW 30 sets a route through which the control functioner 20 and each of the user devices 100 can communicate. After the setting is completed, the Ph-GW 30 sets a route through which each of the user devices 100 can communicate with an opposing communication device, for example, another user device.

The Ph-GW 30 mainly includes five functions. The first is a wavelength control/monitoring function of designating and controlling which wavelength is used by each of the user devices 100 and monitoring the wavelength of a signal. The second is a passing/stopping function of passing a signal in accordance with opening of a path and stopping an unnecessary signal. The third is a aggregation/disaggregation function of a function of aggregating optical signals having wavelengths set to the respective user devices and transferring the optical signals to a relay network, and disaggregating optical signals transferred from the relay network for each of the wavelengths. The fourth is a turning function of enabling turning back at the Ph-GW 30 to which an optical signal is input. The fifth is an extraction/insertion function for performing reproduction, relay, and electrical processing.

The Ph-GW 30 can be configured using various components. Hereinafter, together with description of each configuration example, embodiments for blocking communication or blocking an observed wavelength component in the configuration example will be described.

### First Embodiment

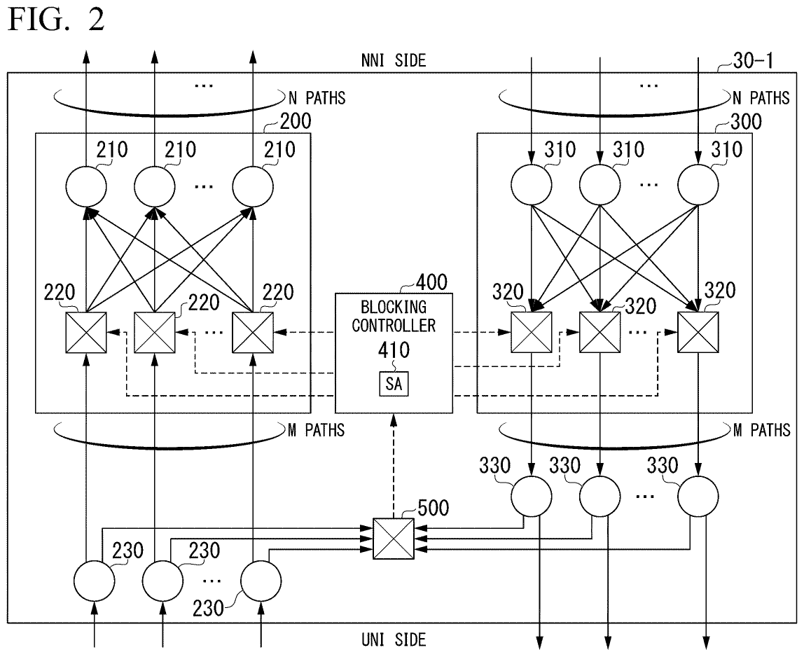

FIG. 2 is a diagram illustrating a configuration example of the Ph-GW 30-1 according to a first embodiment.

In the first embodiment, a Ph-GW to which Configuration Example 2 described in the conventional technology is applied will be described. The Ph-GW 30-1 includes, for example, two MCSs 200 and 300 in the uplink direction and the downlink direction, a blocking controller 400, an observation optical switch 500, M couplers/splitters 230, and M couplers/splitters 330. The couplers/splitters are power splitters or optical couplers having no wavelength dependency. Optical switches may be used instead of the couplers/splitters.

Each of the couplers/splitters 230 receives as input a signal from the UNI side. Each of the couplers/splitters 230 outputs the signal input from the UNI side to the MCS 200 and the observation optical switch 500. Each of the couplers/splitters 330 receives as input a signal from the MCS 300. Each of the couplers/splitters 330 outputs the signal input from the MCS 300 to the user device 100 connected to the UNI side and the observation optical switch 500.

For example, the observation optical switch 500 receives as input signals from the couplers/splitters 230 and the couplers/splitters 330 in a time division manner. The observation optical switch 500 outputs the signals input from the couplers/splitters 230 and the couplers/splitters 330 to the blocking controller 400. In a case where signals are input in a time division manner as described above, the blocking controller 400 can determine from which coupler/splitter 230 or coupler/splitter 330 a signal has been input according to the time when the signal has been input.

The blocking controller 400 acquires wavelengths set to the user terminals 100 from the Ph-GW 30. The blocking controller 400 includes a spectrum analyzer (SA) 410. The blocking controller 400 blocks communication with a user terminal 100 if a wavelength observed by the SA 410 is different from a wavelength acquired from the APN controller 10. The blocking controller 400 causes the 1*N optical switch 220 or the N*1 optical switch 320 to block the signal determined to have a different wavelength.

Note that, regarding blocking, functioners for blocking may be separately included on routes from the user devices to the 1*N optical switches 220 or routes from the N*1 optical switches 320 to the user devices, instead of the 1*N optical switches 220 or the N*1 optical switches 320, and may perform blocking instead of the 1*N optical switches 220 or the N*1 optical switches 320 upon receiving a blocking instruction from 400 instead of the 1*N optical switches 220 or the N*1 optical switches 320. This similarly applies to the following embodiments.

The MCS 200 includes M 1*N optical switches 220 and N M*1 couplers/splitters 210. Each of the 1*N optical switches 220 receives as input a signal on one path from the UNI side input from the coupler/splitter 230.

Each of the 1*N optical switches 220 outputs the signal input from the UNI side to any of the M*1 couplers/splitters 210, or blocks a signal in an instruction from the blocking controller 400. Each of the M*1 couplers/splitters 210 multiplexes signals input from the 1*N optical switches 220 and outputs the multiplexed signals to one path on the NNI side.

The MCS 300 includes N 1*M couplers/splitters 310 and M N*1 optical switches 320. Each of the 1*M couplers/splitters 310 receives as input a signal on one path from the NNI side. Each of the 1*M couplers/splitters 310 splits the signal input from the NNI side and outputs the signals to the N*1 optical switches 320. Each of the N*1 optical switches 320 selects a signal from the 1*M couplers/splitters 310 according to the input port, and outputs the signal to one coupler/splitter 330 or blocks a signal in an instruction from the blocking controller 400.

As described above, by observing the wavelengths of signals input from the user terminals 100 or the wavelengths of signals output to the user terminals 100, it is possible to block a signal having an inappropriate wavelength. Note that one SA may be included for one coupler/splitter 230, one SA may be included for one coupler/splitter 330, and each SA may observe the wavelength of a signal input from the corresponding coupler/splitter 230 or coupler/splitter 330. In this case, the observation optical switch 500 and the SA 410 in the blocking controller 400 are unnecessary. Furthermore, the blocking controller 400 determines whether the wavelength is an inappropriate wavelength on the basis of the wavelength observed at each SA, and instructs the 1*N optical switch 220 or the N*1 optical switch 320 to block the signal according to the determination result.

The couplers/splitters 230 and the couplers/splitters 330 may be optical switches that switch output to the blocking controller 400 and the 1*N optical switches 220, or optical switches that switch output to the observation optical switch 500 and the UNI side. The couplers/splitters 230 and the observation optical switch 500 may be optical switches that switch output to the 1*N optical switches 220 and the blocking controller 400. The couplers/splitters 330 and the observation optical switch 500 may be optical switches that switch output to the UNI side and the blocking controller 400. This similarly applies to the following examples.

In the first embodiment, the MCSs 200 and 300 are examples of an optical cross-connect. The 1*N optical switches 220 and the N*1 optical switches 320 are examples of a blocker. The couplers/splitters 230 and the couplers/splitters 330 are examples of a splitter. The blocking controller 400 is an example of an observer. The observation optical switch 500 is an example of another optical cross-connect.

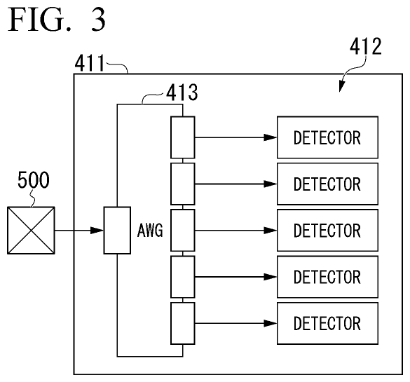

FIG. 3 is a diagram illustrating an alternative configuration of the SA 410. FIG. 3 illustrates the observation optical switch 500 and the alternative SA 411. The alternative SA 411 includes a function of performing demultiplexing for each wavelength to be discriminated, for example, an AWG 413 and a plurality of detectors 412 that detects the intensity of each wavelength demultiplexed by the demultiplexing function. The AWG 413 is an example of a demultiplexer, and only needs to demultiplex an input signal according to the wavelength. In the case of the AWG 413, signals are output from ports different depending on the wavelength. The detectors 412 are included and connected for the respective ports.

By the detectors 412 checking the presence or absence of output of a port corresponding to a wavelength other than the wavelengths set to the user terminals 100 of a signal input by the observation optical switch 500, whether an improper wavelength is output can be observed, for example, by time division multiplexing.

Note that, in order to prevent a wavelength component from being blocked and not detected by a multiplexer/demultiplexer, a demultiplexer having large crosstalk between adjacent channels, that is, between adjacent ports may be used. In that case, crosstalk is calibrated between adjacent ports.

The configuration illustrated in FIG. 3 eliminates the need for time for wavelength sweeping unlike a spectrum analyzer, and thus can shorten measurement processing time required for measurement as compared with a case where wavelength sweeping is performed. In particular, this shortening is suitable for a case where an SA is shared by a plurality of UNIs or NNIs in a time division manner.

### Second Embodiment

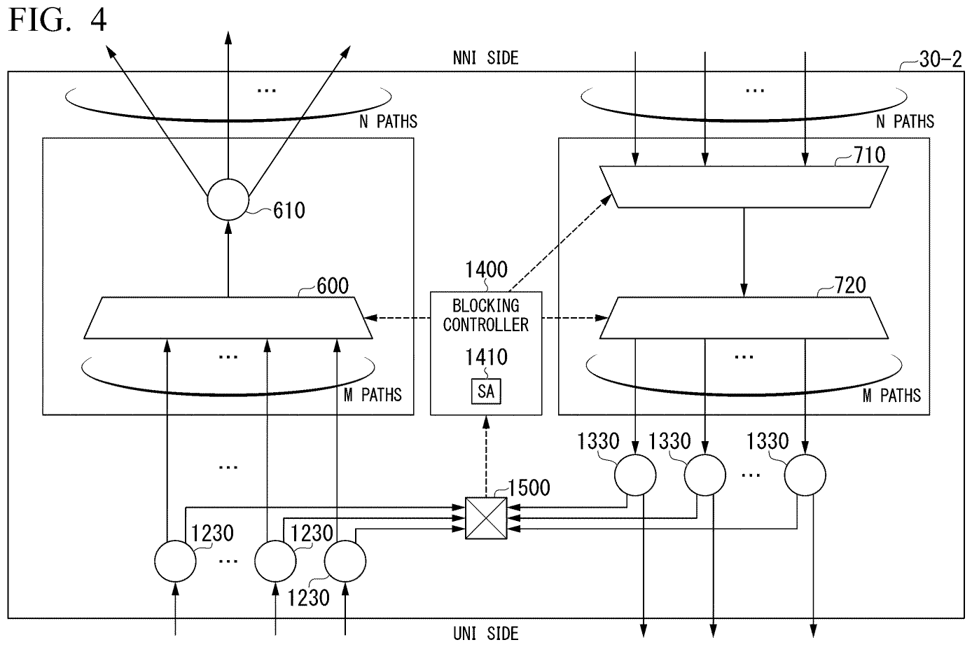

FIG. 4 is a diagram illustrating a configuration example of the Ph-GW 30-2 according to a second embodiment. In the second embodiment, a Ph-GW to which Configuration Example 1 described in the conventional technology is applied will be described. The Ph-GW 30-2 includes an M*1 WSS 600 having an M*1 configuration, a 1*N coupler/splitter 610 having a 1*N configuration, an N*1 WSS 710 having an N*1 configuration, a 1*M WSS 720 having a 1*M configuration, a blocking controller 1400, an observation optical switch 1500, M couplers/splitters 1230, and M couplers/splitters 1330.

Each of the couplers/splitters 1230 receives as input a signal from the UNI side. Each of the couplers/splitters 1230 outputs the signal input from the UNI side to the M*1 WSS 600 and the observation optical switch 1500. Each of the couplers/splitters 1330 receives as input a signal from the 1*M WSS 720. Each of the couplers/splitters 1330 outputs the signal input from the 1*M WSS 720 to a user device 100 connected to the UNI side and the observation optical switch 1500.

For example, the observation optical switch 1500 receives as input signals from the couplers/splitters 1230 and the couplers/splitters 1330 in a time division manner. The observation optical switch 1500 outputs the signals input from the couplers/splitters 1230 and the couplers/splitters 1330 to the blocking controller 1400. In a case where signals are input in a time division manner as described above, the blocking controller 1400 can determine from which coupler/splitter 1230 or coupler/splitter 1330 a signal has been input according to the time when the signal has been input.

The blocking controller 1400 acquires wavelengths assigned to user terminals 100 from an APN controller 10. The blocking controller 1400 includes an SA 1410. The blocking controller 1400 blocks communication with a user terminal 100 if a wavelength observed by the SA 1410 is different from a wavelength acquired from the APN controller 10. The blocking controller 1400 causes the M*1 WSS 600, the N*1 WSS 710, or the 1*M WSS 720 to block the signal determined to have a different wavelength.

Note that, regarding blocking, instead of either the M*1 WSS 600 or the N*1 WSS 710 and the 1*M WSS 720, functioners for blocking may be separately included on either routes from the user devices to the M*1 WSS 600 or routes from the NNI side to the N*1 WSS 710 and routes from the 1*M WSS 720 to the user devices, and may perform blocking instead of either the M*1 WSS 600 or the N*1 WSS 710 and the 1*M WSS 720 upon receiving a blocking instruction from 1400 instead of either the M*1 WSS 600 or the N*1 WSS 710 and the 1*M WSS 720. This similarly applies to the following embodiments.

The M*1 WSS 600 receives as input signals on M paths from the UNI side input from the couplers/splitters 1230. The M*1 WSS 600 multiplexes the signals input from the UNI side according to the combination of an input port and a wavelength, and outputs the signals to the 1*N coupler/splitter 610 or blocks a signal of a combination of an input port and a wavelength in an instruction from the blocking controller 1400. The 1*N coupler/splitter 610 splits the signals input from the M*1 WSS 600 for N paths and outputs the signals to the N paths on the NNI side.

The N*1 WSS 710 receives as input signals on N paths from the NNI side. The N*1 WSS 710 multiplexes the signals input from the NNI side according to the combination of an input port and a wavelength, and outputs the signal to the 1*M WSS 720 or blocks a signal of a combination of an input port and a wavelength in an instruction from the blocking controller 1400. The 1*M WSS 720 outputs the signals from the N*1 WSS 710 to the M couplers/splitters 1330 according to the wavelength, or blocks a signal of a combination of an output port and a wavelength in an instruction from the blocking controller 1400.

As described above, by observing the wavelengths of signals input from the user terminals 100 or the wavelengths of signals output to the user terminals 100, it is possible to block a signal having an inappropriate wavelength. Note that one SA may be included for one coupler/splitter 1230, one SA may be included for one coupler/splitter 1330, and each SA may observe the wavelength of a signal input from the corresponding coupler/splitter 1230 or coupler/splitter 1330. In this case, the observation optical switch 1500 and the SA 410 in the blocking controller 1400 are unnecessary. Furthermore, the blocking controller 1400 determines whether the wavelength is an inappropriate wavelength on the basis of the wavelength observed at each SA, and instructs the M*1 WSS 600, the N*1 WSS 710, or the 1*M WSS 720 to block the signal according to the determination result.

In the second embodiment, a combination of the M*1 WSS 600 and the 1*N coupler/splitter 1230, and a combination of the N*1 WSS 710 and the 1*M WSS 720 are examples of the optical cross-connect. The M*1 WSS 600, the N*1 WSS 710, and the 1*M WSS 720 are examples of the blocker. The coupler/splitter 1330 is an example of the splitter. The blocking controller 1400 is an example of the observer. The observation optical switch 1500 is an example of another optical cross-connect.

### Third Embodiment

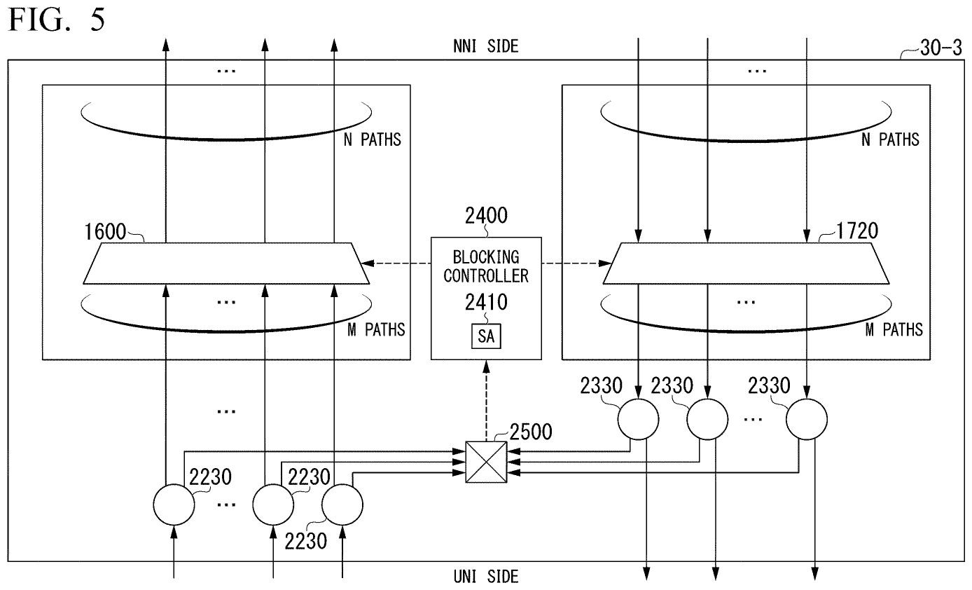

FIG. 5 is a diagram illustrating a configuration example of a Ph-GW 30-3 according to a third embodiment. In the third embodiment, a Ph-GW to which Configuration Example 3 described in the conventional technology is applied will be described. The Ph-GW 30-3 includes an M*N WSS 1600, an N*M WSS 1720, a blocking controller 2400, an observation optical switch 2500, M couplers/splitters 2230, and M couplers/splitters 2330.

Each of the couplers/splitters 2230 receives as input a signal from the UNI side. Each of the couplers/splitters 2230 outputs the signal input from the UNI side to the M*N WSS 1600 and the observation optical switch 2500. Each of the couplers/splitters 2330 receives as input a signal from the N*M WSS 1720. Each of the couplers/splitters 2330 outputs the signal input from the N*M WSS 1720 to a user device 100 connected to the UNI side and the observation optical switch 2500.

For example, the observation optical switch 2500 receives as input signals from the couplers/splitters 2230 and the couplers/splitters 2330 in a time division manner. The observation optical switch 2500 outputs the signals input from the couplers/splitters 2230 and the couplers/splitters 2330 to the blocking controller 2400. In a case where signals are input in a time division manner as described above, the blocking controller 2400 can determine from which coupler/splitter 2230 or coupler/splitter 2330 a signal has been input according to the time when the signal has been input.

The blocking controller 2400 acquires wavelengths assigned to user terminals 100 from an APN controller 10. The blocking controller 2400 includes an SA 2410. The blocking controller 2400 blocks communication with a user terminal 100 if a wavelength observed by the SA 2410 is different from a wavelength acquired from the APN controller 10. The blocking controller 2400 causes the M*N WSS 1600 or the N*M WSS 1720 to block the signal determined to have a different wavelength.

Note that, regarding blocking, instead of the M*N WSS 1600 or the N*M WSS 1720, functioners for blocking may be separately included on either routes from the user devices to the M*N WSS 1600 or routes from the N*M WSS 1720 to the user devices, and may perform blocking instead of the M*N WSS 1600 or the N*M WSS 1720 upon receiving a blocking instruction from 2400 instead of the M*N WSS 1600 or the N*M WSS 1720. This similarly applies to the following embodiments.

The M*N WSS 1600 receives as input signals on M paths from the UNI side input from the couplers/splitters 2230. The M*N WSS 1600 outputs the signals input from the UNI side to any of N paths on the NNI side according to the combination of a port and a wavelength or blocks a signal of a combination of an input port and a wavelength in an instruction from the blocking controller 2400.

The N*M WSS 1720 receives as input signals on the N paths from the NNI side. The N*M WSS 1720 outputs the signals input from the NNI side to the M couplers/splitters 2330 according to the combination of an input port and a wavelength or blocks a signal of a combination of a port and a wavelength in an instruction from the blocking controller 2400.

As described above, by observing the wavelengths of signals input from the user terminals 100 or the wavelengths of signals output to the user terminals 100, it is possible to block a signal having an inappropriate wavelength. Note that one SA may be included for one coupler/splitter 2230, one SA may be included for one coupler/splitter 2330, and each SA may observe the wavelength of a signal input from the corresponding coupler/splitter 2230 or coupler/splitter 2330. In this case, the observation optical switch 2500 and the SA 410 in the blocking controller 2400 are unnecessary. Furthermore, the blocking controller 2400 determines whether the wavelength is an inappropriate wavelength on the basis of the wavelength observed at each SA, and instructs the M*N WSS 1600 or the N*M WSS 1720 to block the signal according to the determination result.

In the third embodiment, the M*N WSS 1600 and the N*M WSS 1720 are examples of the optical cross-connect. The M*N WSS 1600 and the N*M WSS 1720 are examples of the blocker. The couplers/splitters 2230 and the couplers/splitters 2330 are examples of the splitter. The blocking controller 2400 is an example of the observer. The observation optical switch 2500 is an example of another optical cross-connect.

### Fourth Embodiment

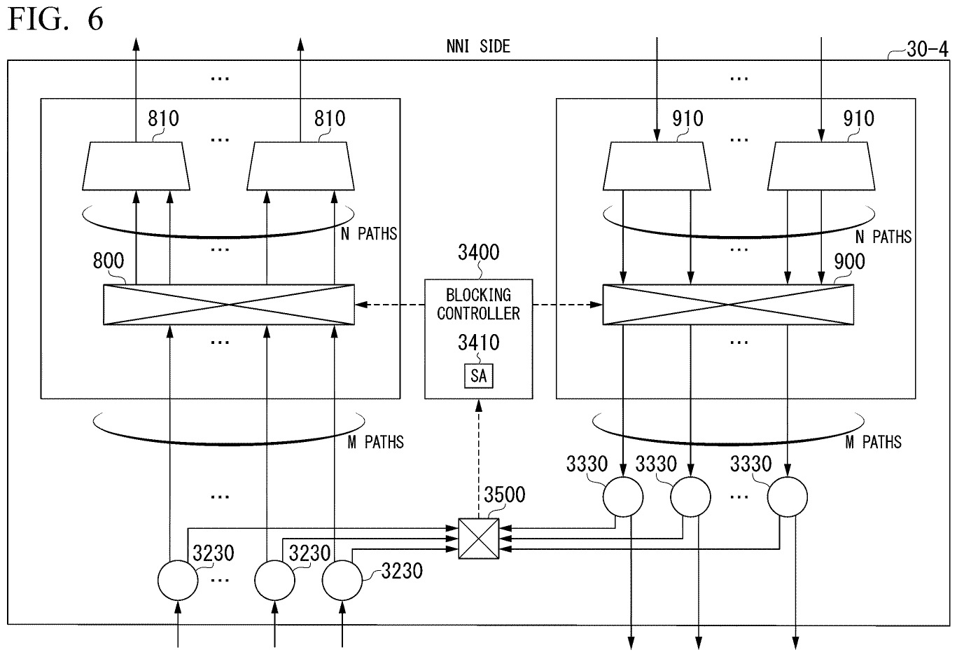

FIG. 6 is a diagram illustrating a configuration example of a Ph-GW 30-4 according to a fourth embodiment. In the fourth embodiment, a Ph-GW to which Configuration Example 4 described in the conventional technology is applied will be described. The Ph-GW 30-4 includes an M*N optical switch 800, AWGs 810, AWGs 910, an N*M optical switch 900, a blocking controller 3400, an observation optical switch 3500, M couplers/splitters 3230, and M couplers/splitters 3330.

Each of the couplers/splitters 3230 receives as input a signal from the UNI side. Each of the couplers/splitters 3230 outputs the signal input from the UNI side to the M*N optical switch 800 and the observation optical switch 3500. Each of the couplers/splitters 3330 receives as input a signal from the N*M optical switch 900. Each of the couplers/splitters 3330 outputs the signal input from the N*M optical switch 900 to a user device 100 connected to the UNI side and the observation optical switch 3500.

For example, the observation optical switch 3500 receives as input signals from the couplers/splitters 3230 and the couplers/splitters 3330 in a time division manner. The observation optical switch 3500 outputs the signals input from the couplers/splitters 3230 and the couplers/splitters 3330 to the blocking controller 3400. In a case where signals are input in a time division manner as described above, the blocking controller 3400 can determine from which coupler/splitter 3230 or coupler/splitter 3330 a signal has been input according to the time when the signal has been input.

The blocking controller 3400 acquires wavelengths assigned to user terminals 100 from an APN controller 10. The blocking controller 3400 includes an SA 3410. The blocking controller 3400 blocks communication with a user terminal 100 if a wavelength observed by the SA 3410 is different from a wavelength acquired from the APN controller 10. The blocking controller 3400 causes the M*N optical switch 800 or the N*M optical switch 900 to block the signal determined to have a different wavelength.

Note that, regarding blocking, instead of the M*N optical switch 800 or the N*M optical switch 900, functioners for blocking may be separately included on routes from the user devices to the NNI side or routes from the NNI side to the user devices, and may perform blocking instead of the M*N optical switch 800 or the N*M optical switch 900 upon receiving a blocking instruction from 3400 instead of the M*N optical switch 800 or the N*M optical switch 900. This similarly applies to the following embodiments.

The M*N optical switch 800 receives as input signals on M paths from the UNI side input from the couplers/splitters 3230. The M*N optical switch 800 outputs the signals input from the UNI side to any port of any AWG 810 according to the input port or blocks a signal of a port in an instruction of the blocking controller 3400. Each of the AWGs 810 multiplexes signals input from the M*N optical switch 800 according to the combination of an input port and a wavelength, and outputs the signals to the NNI side.

Each of the AWGs 910 outputs a signal input from the NNI side to any of N ports of the N*M optical switch 900 according to the combination of an input port and a wavelength. The N*M optical switch 900 outputs signals input from the AWGs 910 to any of the M couplers/splitters 3330 according to the input port or blocks a signal of a port in an instruction from the blocking controller 3400.

As described above, by observing the wavelengths of signals input from the user terminals 100 or the wavelengths of signals output to the user terminals 100, it is possible to block a signal having an inappropriate wavelength. Note that one SA may be included for one coupler/splitter 3230, one SA may be included for one coupler/splitter 3330, and each SA may observe the wavelength of a signal input from the corresponding coupler/splitter 3230 or coupler/splitter 3330. In this case, the observation optical switch 3500 and the SA 410 in the blocking controller 3400 are unnecessary. Furthermore, the blocking controller 3400 determines whether the wavelength is an inappropriate wavelength on the basis of the wavelength observed at each SA, and instructs the M*N optical switch 800 or the N*M optical switch 900 to block the signal according to the determination result. Note that the AWGs 810 and the AWGs 910 may be other than AWGs as long as demultiplexing can be performed for each wavelength or a plurality of wavelengths can be multiplexed.

In the fourth embodiment, the M*N optical switch 800 and the N*M optical switch 900 are examples of the optical cross-connect. The M*N optical switch 800 and the N*M optical switch 900 are examples of the blocker.

The couplers/splitters 3230 and the couplers/splitters 3330 are examples of the splitter. The blocking controller 3400 is an example of the observer. The observation optical switch 3500 is an example of another optical cross-connect.

### Fifth Embodiment

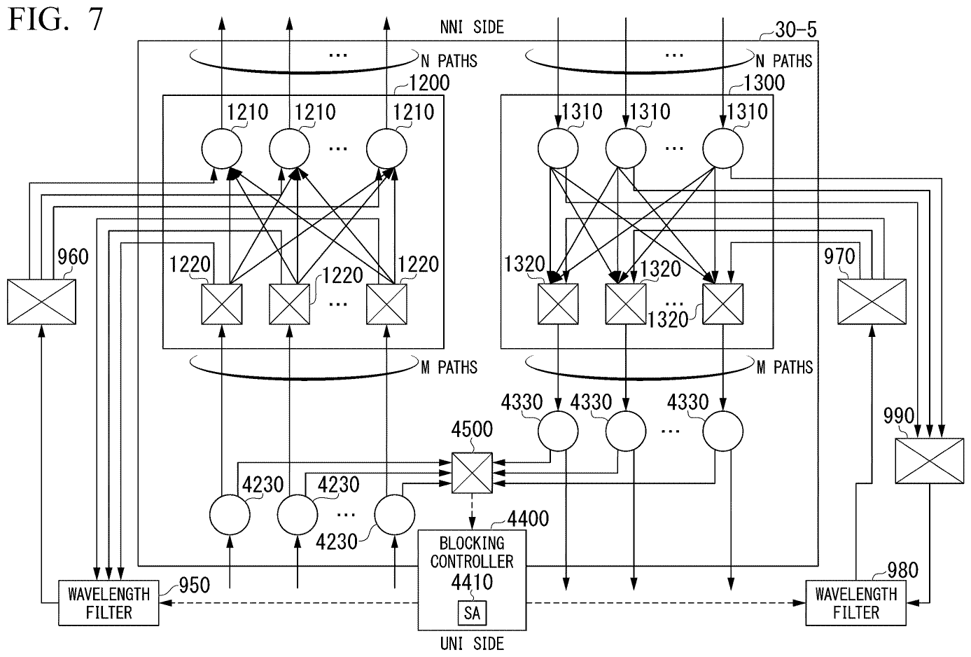

FIG. 7 is a diagram illustrating a configuration example of a Ph-GW 30-5 according to a fifth embodiment. The fifth embodiment is a modification of the first embodiment, and is mainly modified in that wavelength filters are included. The Ph-GW 30-5 includes two MCSs 1200 and 1300, a blocking controller 4400, an observation optical switch 4500, M couplers/splitters 4230, M couplers/splitters 4330, filter optical switches 960, 970, and 990, and wavelength filters 950 and 980.

In the following embodiments, one wavelength filter is illustrated in each of the uplink direction and the downlink direction, but a plurality of wavelength filters may be used. In the case of a plurality of wavelength filters, the number of ports to be added to WSSs, couplers/splitters, and optical switches is increased according to the number of the wavelength filters.

Each of the couplers/splitters 4230 receives as input a signal from the UNI side. Each of the couplers/splitters 4230 outputs the signal input from the UNI side to the MCS 1200 and the observation optical switch 4500. Each of the couplers/splitters 4330 receives as input a signal from the MCS 1300. Each of the couplers/splitters 4330 outputs the signal input from the MCS 1300 to a user device 100 connected to the UNI side and the observation optical switch 4500.

For example, the observation optical switch 4500 receives as input signals from the couplers/splitters 4230 and the couplers/splitters 4330 in a time division manner. The observation optical switch 4500 outputs the signals input from the couplers/splitters 4230 and the couplers/splitters 4330 to the blocking controller 4400. In a case where signals are input in a time division manner as described above, the blocking controller 4400 can determine from which coupler/splitter 4230 or coupler/splitter 4330 a signal has been input according to the time when the signal has been input.

The blocking controller 4400 acquires wavelengths assigned to user terminals 100 from an APN controller 10.

The blocking controller 4400 includes an SA 4410. If a wavelength observed by the SA 4410 is different from a wavelength acquired from the APN controller 10, the blocking controller 4400 inputs the signal determined to have a different wavelength to the wavelength filter 950 and the wavelength filter 980. The wavelength filter 950 and the wavelength filter 980 are wavelength-tunable filters, and wavelengths are set such that only a set wavelength is transmitted. A signal determined not to have a different wavelength is obtained by filtering a signal determined to have a different wavelength out from a signal that has passed through the wavelength filter 950, and then output to the filter optical switch 960. A signal that has passed through the wavelength filter 980 is output to the filter optical switch 970. Output of the filter optical switch 960 from the UNI side to the NNI side is output to an (M+1)*1 coupler/splitter 1210 to which the output is to be output, and output of the filter optical switch 970 from the NNI side to the UNI side is input to an (N+1)*1 optical switch 1320 to which the output is to be output. Although input to the (N+1)*1 optical switches 1320 is performed in the drawing, the couplers/splitters 4330 to which the respective N*1 optical switches 1320 perform output may be changed from 1*2 couplers/splitters to 2*2 couplers/splitters and receive input, instead of performing input to the (N+1)*1 optical switches 1320. In this case, the scale of switch 1320 is reduced from (N+1)*1 to N*1. This similarly applies to the following examples.

The MCS 1200 includes M (N+1)*1 optical switches 1220 and N (M+1)*1 couplers/splitters 1210. Each of the 1*(N+1) optical switches 1220 receives as input a signal on one path from the UNI side input from the coupler/splitter 4230. Each of the 1*(N+1) optical switches 1220 outputs the signal input from the UNI side to any of the (M+1)*1 couplers/splitters 1210 and to the wavelength filter 950. The wavelength filter 950 blocks a wavelength in an instruction from the blocking controller 4400. A signal that has passed through the wavelength filter 950 is output to the filter optical switch 960. The filter optical switch 960 outputs the signal output from the wavelength filter 950 to the (M+1)*1 couplers/splitters 1210. Each of the (M+1)*1 couplers/splitters 1210 multiplexes a signal input from the 1*N optical switch 1220 and a signal output from the filter optical switch 960 and outputs the multiplexed signals to one path on the NNI side.

The MCS 1300 includes N 1*(M+1) couplers/splitters 1310 and M (N+1)*1 optical switches 1320. Each of the 1*(M+1) couplers/splitters 1310 receives as input a signal on one path from the NNI side.

Each of the 1*(M+1) couplers/splitters 1310 splits the signal input from the NNI side and outputs the signals to the (N+1)*1 optical switches 1320 and the filter optical switch 990. The filter optical switch 990 outputs a signal output from the NNI side to the wavelength filter 980. The wavelength filter 980 blocks a wavelength in an instruction from the blocking controller 4400. A signal that has passed through the wavelength filter 980 is output to the filter optical switch 970. Each of the (N+1)*1 optical switches 1320 outputs signals from the 1*(M+1) couplers/splitters 1310 to the coupler/splitter 4330.

As described above, by observing the wavelengths of signals input from the user terminals 100 or the wavelengths of signals output to the user terminals 100, it is possible to block a signal having an inappropriate wavelength. Note that one SA may be included for one coupler/splitter 4230, one SA may be included for one coupler/splitter 4330, and each SA may observe the wavelength of a signal input from the corresponding coupler/splitter 4230 or coupler/splitter 4330. In this case, the observation optical switch 4500 and the SA 4410 in the blocking controller 4400 are unnecessary. Furthermore, the blocking controller 4400 determines whether the wavelength is an inappropriate wavelength on the basis of the wavelength observed at each SA, and instructs the wavelength filter 950 or the wavelength filter 980 to block the signal according to the determination result. Note that an optical switch that selects a signal output from the 1*(N+1) optical switches 1220 may be included in front of the wavelength filter 950.

In the fifth embodiment, the MCSs 1200 and 1300 are examples of the optical cross-connect. The (N+1)*1 optical switches 1220 and the 1*(M+1) couplers/splitters 1310 are examples of the blocker. The couplers/splitters 4230 and the couplers/splitters 4330 are examples of the splitter. The blocking controller 4400 is an example of the observer. The observation optical switch 4500 is an example of another optical cross-connect.

### Sixth Embodiment

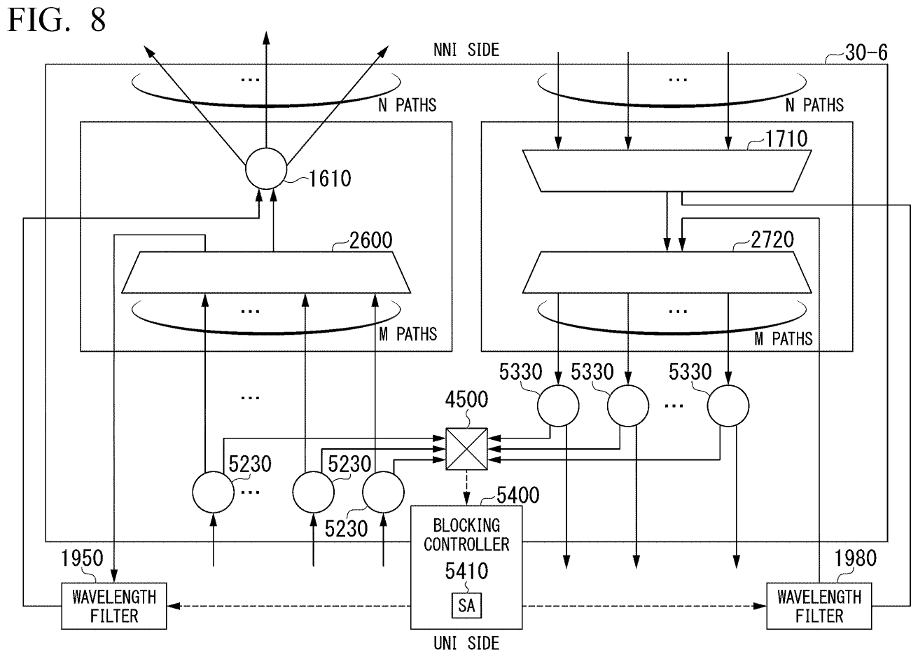

FIG. 8 is a diagram illustrating a configuration example of a Ph-GW 30-6 according to a sixth embodiment. The sixth embodiment is a modification of the second embodiment, and is mainly modified in that wavelength filters are included. The Ph-GW 30-6 includes an M*2 WSS 2600, a 2*N coupler/splitter 1610, an N*2 WSS 1710, a 2*M WSS 2720, a blocking controller 5400, an observation optical switch 4500, M couplers/splitters 5230, M couplers/splitters 5330, and wavelength filters 1950 and 1980.

Each of the couplers/splitters 5230 receives as input a signal from the UNI side. Each of the couplers/splitters 5230 outputs the signal input from the UNI side to the M*2 WSS 2600 and the observation optical switch 4500. Each of the couplers/splitters 5330 receives as input a signal from the 2*M WSS 2720. Each of the couplers/splitters 5330 outputs the signal input from the 2*M WSS 2720 to a user device 100 connected to the UNI side and the observation optical switch 4500.

For example, the observation optical switch 4500 receives as input signals from the couplers/splitters 5230 and the couplers/splitters 5330 in a time division manner. The observation optical switch 4500 outputs the signals input from the couplers/splitters 5230 and the couplers/splitters 5330 to the blocking controller 5400.

In a case where signals are input in a time division manner as described above, the blocking controller 5400 can determine from which coupler/splitter 5230 or coupler/splitter 5330 a signal has been input according to the time when the signal has been input.

The blocking controller 5400 acquires wavelengths set to the user terminals 100 from the Ph-GW 30. The blocking controller 5400 includes an SA 5410. If a wavelength observed by the SA 5410 is different from a set wavelength, the blocking controller 5400 causes the wavelength filter 1950 or the wavelength filter 1980 to block the wavelength component determined to have a different wavelength.

The M*2 WSS 2600 receives as input signals on M paths from the UNI side input from the couplers/splitters 5230. The M*2 WSS 2600 multiplexes the signals input from the UNI side according to the combination of an input port and a wavelength, and outputs the signals to the 2*N coupler/splitter 1610 and the wavelength filter 1950. The wavelength filter 1950 blocks a wavelength in an instruction from the blocking controller 5400. The wavelength filter 1950 outputs a signal to the 2*N coupler/splitter 1610. The 2*N coupler/splitter 1610 splits a signal input from the M*2 WSS 2600 and a signal input from the wavelength filter 1950 for N paths and outputs the signals to the N paths on the NNI side.

The N*2 WSS 1710 receives as input signals on N paths from the NNI side. The N*2 WSS 1710 multiplexes the signals input from the NNI side, and outputs the signals to the 2*M WSS 2720 and the wavelength filter 1980. Only a signal in which a combination of an input port and a wavelength is improper is output to the wavelength filter 1980. The wavelength filter 1980 blocks a wavelength in an instruction from the blocking controller 5400. The wavelength filter 1980 outputs a signal to the 2*M WSS 2720. The 2*M WSS 2720 outputs a signal from the N*2 WSS 1710 and a signal from the wavelength filter 1980 to the M couplers/splitters 5330 according to the wavelength.

As described above, by observing the wavelengths of signals input from the user terminals 100 or the wavelengths of signals output to the user terminals 100, it is possible to block a signal having an inappropriate wavelength. Note that one SA may be included for one coupler/splitter 5230, one SA may be included for one coupler/splitter 5330, and each SA may observe the wavelength of a signal input from the corresponding coupler/splitter 5230 or coupler/splitter 5330. In this case, the observation optical switch 4500 and the SA 410 in the blocking controller 5400 are unnecessary. Furthermore, the blocking controller 5400 determines whether the wavelength is an inappropriate wavelength on the basis of the wavelength observed at each SA, and instructs the wavelength filter 1950 or the wavelength filter 1980 to block a wavelength component of the inappropriate wavelength according to the determination result.

In the sixth embodiment, a combination of the M*2 WSS 2600 and the 2*N coupler/splitter, and a combination of the N*2 WSS 1710 and the 2*M WSS 2720 are examples of the optical cross-connect. The wavelength filter 1950 and the wavelength filter 1980 are examples of the blocker. The couplers/splitters 5330 are examples of the splitter.

The blocking controller 5400 is an example of the observer. The observation optical switch 4500 is an example of another optical cross-connect.

### Seventh Embodiment

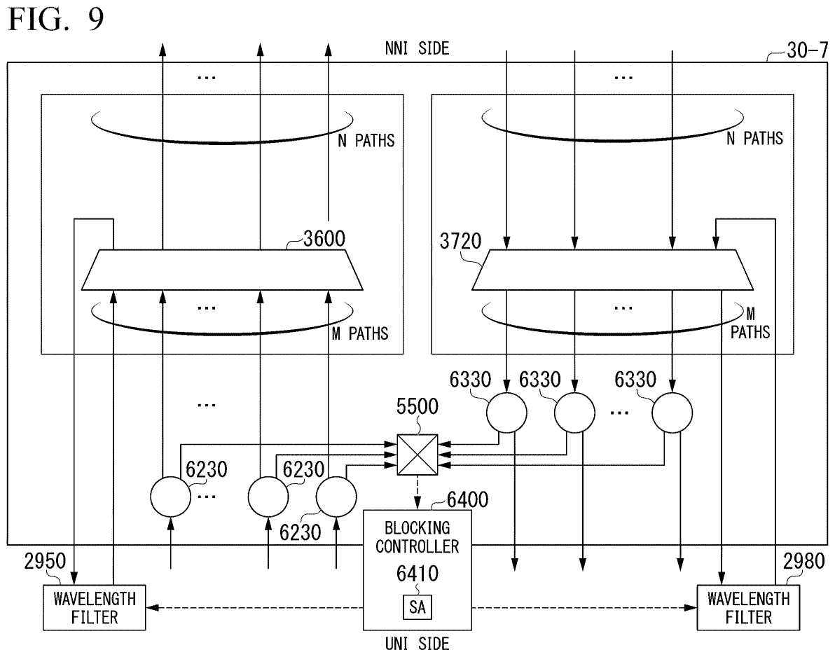

FIG. 9 is a diagram illustrating a configuration example of a Ph-GW 30-7 according to a seventh embodiment. The seventh embodiment is a modification of the third embodiment, and is mainly modified in that wavelength filters are included. The Ph-GW 30-7 includes an (M+1)*(N+1) WSS 3600, an (N+1)*(M+1) WSS 3720, a blocking controller 6400, an observation optical switch 5500, M couplers/splitters 6230, M couplers/splitters 6330, and wavelength filters 2950 and 2980.

Each of the couplers/splitters 6230 receives as input a signal from the UNI side. Each of the couplers/splitters 6230 outputs the signal input from the UNI side to the (M+1)*(N+1) WSS 3600 and the observation optical switch 5500. Each of the couplers/splitters 6330 receives as input a signal from the (N+1)*(M+1) WSS 3720. Each of the couplers/splitters 6330 outputs the signal input from the (N+1)*(M+1) WSS 3720 to a user device 100 connected to the UNI side and the observation optical switch 5500.

For example, the observation optical switch 5500 receives as input signals from the couplers/splitters 6230 and the couplers/splitters 6330 in a time division manner. The observation optical switch 5500 outputs the signals input from the couplers/splitters 6230 and the couplers/splitters 6330 to the blocking controller 6400. In a case where signals are input in a time division manner as described above, the blocking controller 6400 can determine from which coupler/splitter 6230 or coupler/splitter 6330 a signal has been input according to the time when the signal has been input.

The blocking controller 6400 acquires wavelengths assigned to user terminals 100 from an APN controller 10. The blocking controller 6400 includes an SA 6410. The blocking controller 6400 blocks communication with a user terminal 100 if a wavelength observed by the SA 6410 is different from a wavelength acquired from the APN controller 10. The blocking controller 6400 causes the wavelength filter 2950 or the wavelength filter 2980 to block the wavelength component of the wavelength determined to have a different wavelength.

The (M+1)*(N+1) WSS 3600 receives as input signals on M paths from the UNI side input from the couplers/splitters 6230 and a signal output from the wavelength filter 2950. The (M+1)*(N+1) WSS 3600 outputs the signals input from the UNI side to any of N paths on the NNI side and the wavelength filter 2950 according to the combination of an input port and a wavelength. The wavelength filter 2950 blocks a wavelength in an instruction from the blocking controller 6400.

The (N+1)*(M+1) WSS 3720 receives as input signals on the N paths from the NNI side and a signal of the wavelength filter 2980. The (N+1)*(M+1) WSS 3720 outputs the signals input from the NNI side and the signal input from the wavelength filter 2980 to the M couplers/splitters 6330 and the wavelength filter 2980 according to the combination of an input port and a wavelength. The wavelength filter 2980 blocks a wavelength in an instruction from the blocking controller 6400.

As described above, by observing the wavelengths of signals input from the user terminals 100 or the wavelengths of signals output to the user terminals 100, it is possible to block a signal having an inappropriate wavelength. Note that one SA may be included for one coupler/splitter 6230, one SA may be included for one coupler/splitter 6330, and each SA may observe the wavelength of a signal input from the corresponding coupler/splitter 6230 or coupler/splitter 6330. In this case, the observation optical switch 5500 and the SA 6410 in the blocking controller 6400 are unnecessary. Furthermore, the blocking controller 6400 determines whether the wavelength is an inappropriate wavelength on the basis of the wavelength observed at each SA, and instructs the wavelength filter 2950 or the wavelength filter 2980 to block the wavelength component according to the determination result.

In the seventh embodiment, the (M+1)*(N+1) WSS 3600 and the (N+1)*(M+1) WSS 3720 are examples of the optical cross-connect. The wavelength filter 2950 and the wavelength filter 2980 are examples of the blocker. The couplers/splitters 6230 and the couplers/splitters 6330 are examples of the splitter. The blocking controller 6400 is an example of the observer. The observation optical switch 5500 is an example of another optical cross-connect.

### Eighth Embodiment

FIG. 10 is a diagram illustrating a configuration example of a Ph-GW 30-8 according to an eighth embodiment. The eighth embodiment is a modification of the fourth embodiment, and is mainly modified in that wavelength filters are included. The Ph-GW 30-8 includes an (M+1)*(N+1) optical switch 1800, AWGs 1810, AWGs 1910, an (N+1)*(M+1) optical switch 1900, a blocking controller 7400, an observation optical switch 6500, M couplers/splitters 7230, M couplers/splitters 7330, and wavelength filters 3950 and 3980.

Each of the couplers/splitters 7230 receives as input a signal from the UNI side. Each of the couplers/splitters 7230 outputs the signal input from the UNI side to the (M+1)*(N+1) optical switch 1800 and the observation optical switch 6500. Each of the couplers/splitters 7330 receives as input a signal from the (N+1)*(M+1) optical switch 1900. Each of the couplers/splitters 7330 outputs the signal input from the (N+1)*(M+1) optical switch 1900 to a user device 100 connected to the UNI side and the observation optical switch 6500.

For example, the observation optical switch 6500 receives as input signals from the couplers/splitters 7230 and the couplers/splitters 7330 in a time division manner. The observation optical switch 6500 outputs the signals input from the couplers/splitters 7230 and the couplers/splitters 7330 to the blocking controller 7400.

In a case where signals are input in a time division manner as described above, the blocking controller 7400 can determine from which coupler/splitter 7230 or coupler/splitter 7330 a signal has been input according to the time when the signal has been input.

The blocking controller 7400 acquires wavelengths set to the user terminals 100 from the Ph-GW 30. The blocking controller 7400 includes an SA 7410. If a wavelength observed by the SA 7410 is different from a wavelength acquired by an APN controller 10, the blocking controller 7400 causes the wavelength filter 3950 or the wavelength filter 3980 to block the wavelength component determined to have a different wavelength.

The M*N optical switch 1800 receives as input signals on M paths from the UNI side input from the couplers/splitters 7230 and a signal output from the wavelength filter 3950. The (M+1)*(N+1) optical switch 1800 outputs the signals input from the UNI side to any port of any AWG 1810 according to the input port and the wavelength filter 3950. Each of the AWGs 1810 multiplexes the signals input from the (M+1)*(N+1) optical switch 1800 according to the combination of an input port and a wavelength, and outputs the signals to the NNI side. The wavelength filter 3950 blocks a wavelength in an instruction from the blocking controller 7400.

Each of the AWGs 1910 outputs a signal input from the NNI side to any of N ports of the (N+1)*(M+1) optical switch 1900 according to the combination of an input port and a wavelength. The (N+1)*(M+1) optical switch 1900 outputs the signals input from the AWGs 1910 to any of the M couplers/splitters 7330 and the wavelength filter 3980 according to the input port. The wavelength filter 3980 blocks a wavelength in an instruction from the blocking controller 7400. The wavelength filter 3980 outputs a signal to the (N+1)*(M+1) optical switch 1900.

As described above, by observing the wavelengths of signals input from the user terminals 100 or the wavelengths of signals output to the user terminals 100, it is possible to block a signal having an inappropriate wavelength. Note that one SA may be included for one coupler/splitter 7230, one SA may be included for one coupler/splitter 7330, and each SA may observe the wavelength of a signal input from the corresponding coupler/splitter 7230 or coupler/splitter 7330. In this case, the observation optical switch 6500 and the SA 410 in the blocking controller 7400 are unnecessary. Furthermore, the blocking controller 7400 determines whether the wavelength is an inappropriate wavelength on the basis of the wavelength observed at each SA, and instructs the (M+1)*(N+1) optical switch 1800 or the (N+1)*(M+1) optical switch 1900 to block a wavelength component determined to be the inappropriate wavelength according to the determination result.

In the eighth embodiment, the (M+1)*(N+1) optical switch 1800 and the (N+1)*(M+1) optical switch 1900 are examples of the optical cross-connect. The wavelength filters 3950 and 3980 are examples of the blocker. The couplers/splitters 7230 and the couplers/splitters 7330 are examples of the splitter. The blocking controller 7400 is an example of the observer. The observation optical switch 6500 is an example of another optical cross-connect.

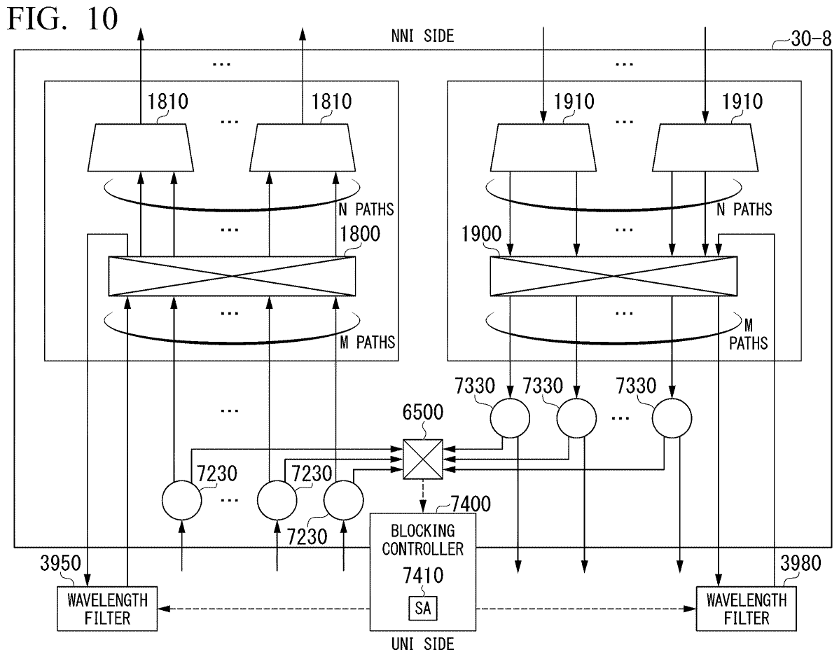

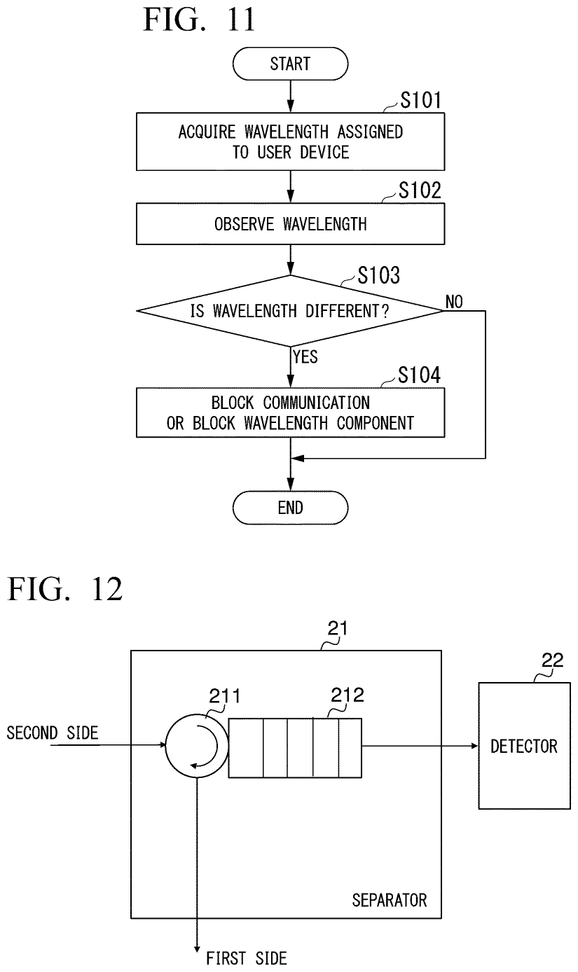

FIG. 11 is a flowchart illustrating a flow of processing common in each embodiment described above. In FIG. 11, the blocking controller acquires a wavelength assigned to a user terminal (step S101). Next, the SA observes the wavelength of a signal output from the user terminal to the optical switch or the wavelength of a signal output from the optical switch to the user terminal (step S102). A wavelength controller determines whether the observed wavelength is different from the acquired wavelength (step S103). If the observed wavelength is different from the acquired wavelength (step S103: YES), the blocking controller blocks communication with the user terminal or blocks a wavelength component of the observed wavelength (step S104). If the observed wavelength is not different from the acquired wavelength (step S103: NO), the blocking controller ends the processing as it is.

In the above-described embodiments, the configuration for detecting the intensity (light intensity) of a wavelength component has been described with reference to FIG. 3, but another configuration example for detecting the light intensity will be described with reference to the drawings. In the configuration described below, a configuration including a separator and a detector or a configuration related to the separator and the detector is illustrated. The separator executes separation processing for wavelength-separating an input optical signal, a desired signal, and a residual signal. By execution of the separation processing, the desired separation signal and the residual separation signal are wavelength-separated.

Here, assume that the desired separation signal is a signal of a predetermined wavelength component, the residual separation signal is a signal of a wavelength component other than the predetermined wavelength component to be detected and blocked by the detector, a signal light is input from the second side, the desired separation signal is output from the first side, and the residual separation signal is terminated by the detector.

The detector detects the light intensity of the separated residual separation signal. Upon detecting the residual separation signal with a predetermined light intensity or more, the detector outputs a control signal for blocking or filtering the input optical signal. In this case, the detector may record information (log) indicating that the residual separation signal has been detected with a predetermined light intensity or more. The detector may be configured to be non-reflective. That is, the detector may be configured not to reflect the input from the separator. Such a log may be recorded along with a detection time of the residual separation signal. By recording the log in this manner, for example, when an inquiry occurs, it is possible to appropriately respond to the inquiry. Such a log may also be recorded with the detected intensity or with the detected time and intensity.

FIG. 12 is a diagram illustrating a configuration example in which the separator 21 is configured using a fiber bragg grating (FBG). The FBG is configured by engraving a diffraction grating in an optical fiber. When light is incident on the FBG, only light of a specific wavelength component corresponding to the interval between diffraction gratings is reflected, and light of other wavelength components passes. By utilizing such characteristics, the separator 21 using the FBG can be configured.

The separator 21 includes a circulator 211 and an FBG 212. The circulator 211 inputs an optical signal input from the second side to the FBG 212. The circulator 211 outputs an optical signal input from the FBG 212 to the first side. The circulator 211 may be configured using, for example, a coupler/splitter. In a case where the circulator 211 is configured using a 2*2 coupler/splitter, two ports on one side function as an input port and an output port, one of two ports on the opposite side is connected to the FBG 212, and the other port is configured with non-reflection termination. The circulator 211 may be configured using a 2*1 coupler/splitter such that there is no open end. In this case, two ports on one side function as an input port and an output port, and one port on the opposite side is connected to the FBG 212. The FBG 212 reflects a desired separation signal and transmits a residual separation signal.

In FIG. 12, the FBG 212 corresponds to a demultiplexer. The wavelength to be detected is adjusted by the tension or the temperature applied to the FBG filter 212.

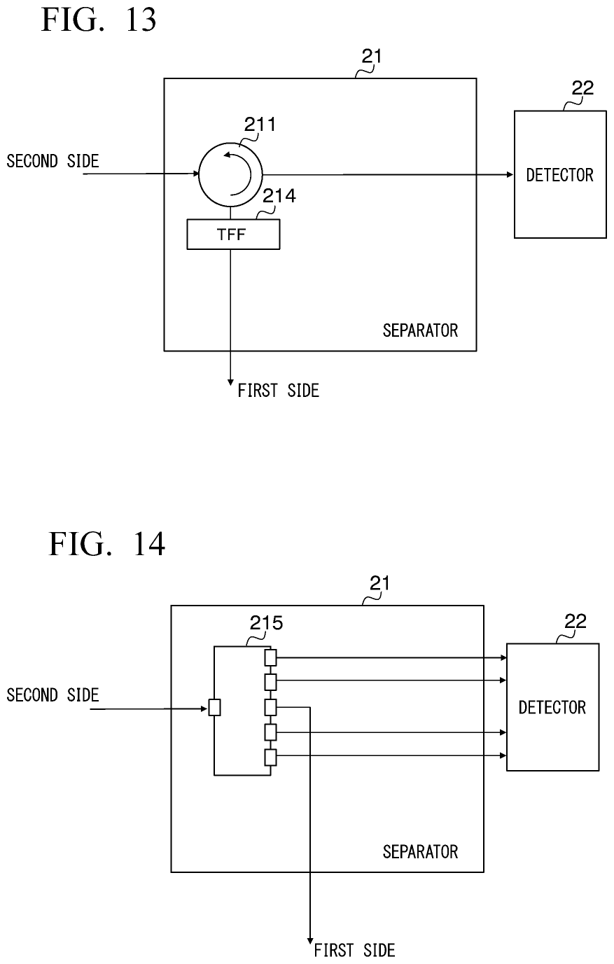

FIG. 13 is a diagram illustrating a configuration example in which the separator 21 is configured using a TFF. The separator 21 includes the circulator 211 and a TFF 214. The circulator 211 inputs an optical signal input from the second side to the TFF 214. The circulator 211 inputs an optical signal input from the TFF 214 to a detector 22.

The traveling direction of the light of the circulator 211 is reversely rotated in a case of a configuration in which the element in the separator 21 reflects a desired separation signal as in the FBG 212, for example, and in a case of a configuration in which the element transmits a desired separation signal as in the TFF 214, for example.

The TFF 214 transmits a desired separation signal and reflects an optical signal of a residual separation signal. The residual separation signal reflected by the TFF 214 is input to the detector 22 via the circulator 211.

The TFF 214 corresponds to a demultiplexer. The wavelength to be detected is adjusted by changing the incident angle from the circulator 211 to the TFF 214 or the film thickness of the TFF 214.

FIG. 14 is a diagram illustrating a configuration example in which the separator 21 is configured using an AWG. The separator 21 includes an AWG 215. The AWG 215 outputs an optical signal input from the second side from a port corresponding to a wavelength. Among a plurality of output ports of the AWG 215, the output port from which a desired separation signal is output is connected to the first side. It is desirable that all the remaining output ports are connected to the detector 22. This is to prevent detection omission of a residual separation signal from occurring. Input to the detector 22 may be input after being multiplexed by a multiplexer/demultiplexer such as an AWG. An isolator may be included between the separator 21 and the detector 22. The isolator may be included, for example, between the AWG 215 and the multiplexer/demultiplexer. In this case, the cost increases because the number of isolators increases, but a higher effect can be obtained.

Although a single-input AWG is used in FIG. 14, a double-input AWG may be used. In that case, in order to reduce the influence of reflection, ports that are not used are non-reflection terminated or an isolator is connected.

In FIG. 14, the AWG 215 corresponds to a demultiplexer. A residual separation signal is detected by, among pieces of light input from the second side, a desired separation signal being output to the first side, and the residual separation signal being output to the detector 22. In the case of this configuration, detected wavelengths are adjusted by changing ports that perform detection. Alternatively, instead of changing the ports, it is also possible to perform adjustment by changing the refractive indexes by the temperature or voltage.

The configuration illustrated in FIG. 15 is substantially similar to the configuration in which the number of output ports of the AWG 215 to the detector 22 is two in the separator 21 described as FIG. 14. In the configuration of FIG. 14, an AWG that demultiplexes and outputs different wavelengths at FSR intervals is assumed. Although five waves are illustrated in FIG. 14, ports are included as many as the number of wavelengths to be detected as residual separation signals in addition to a desired separation signal. Assuming that the wavelength band to be detected is 32 waves, one port for the desired separation signal and 31 ports for the residual separation signals are necessary. Therefore, there is an issue that the number of connection lines with the detector 22 becomes large. In order to solve this issue, for example, a configuration is also considered in which a multiplexer multiplexes the ports for the residual separation signals and then passes the result to the detector 22. In such a configuration, detection sensitivity in the detector 22 may deteriorate due to a loss in the multiplexer. For example, when the number of ports is 2\hat{ }N (2 to the N-th power), a split loss is generated by 3N dB. As described above, when the number of ports is 32, N=5 is satisfied, and thus the loss is 15 dB (~ 1/32). As the multiplexer, a multiplexer 216 whose characteristics substantially match those of the AWG 215 is used.

Accordingly, in the modification of the AWG illustrated in FIG. 15, the ports that output wavelengths on the long wavelength side of a desired separation signal and the short wavelength side of a residual separation signal collectively output a plurality of FSRs of wavelengths. In the AWG 215 of FIG. 14, at least one of the upper two ports or the lower two ports of the AWG 215 is combined into one port. Either the upper side or the lower side has a longer wavelength than the wavelength of the desired separation signal, and the opposite side has a shorter wavelength. In FIG. 15, the AWG 215 corresponds to a demultiplexer. FIG. 15 has a configuration in which the ports from which residual separation signals are output in FIG. 14 are collected.

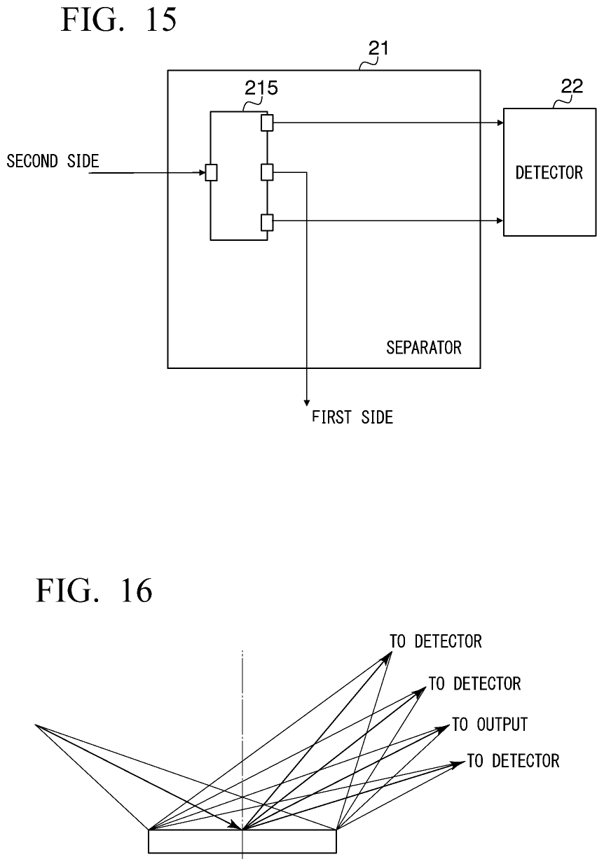

In the specific example of a diffraction grating illustrated in FIG. 16, a desired separation signal is transmitted through the diffraction grating and output from the right end to the first side in the drawing. In addition, a residual separation signal passes through the diffraction grating and is input to the detector 22 from the right end of the drawing. Such a diffraction grating may be applied, for example, in place of the AWG 215 illustrated in FIG. 14. In the specific example of the diffraction grating illustrated in FIG. 15, a desired separation signal is reflected by a reflector 217 disposed at the right end of the diffraction grating illustrated in the drawing, and is output from the left end of the diffraction grating to the first side via the circulator 211. In addition, a residual separation signal passes through the diffraction grating and is input to the detector 22 from the right end of the drawing. Note that, in these configurations, a plurality of outputs may be bundled and aggregated for each wavelength. At this time, the range of wavelengths to be aggregated is equal to or more than the wavelength range in which improper light needs to be detected. In FIG. 14, the single-input multiple-output is illustrated, but if multiple-input multiple-output is used, it can be similarly applied to a configuration using the multiple-input multiple-output AWG 215.

The diffraction grating illustrated in FIG. 16 corresponds to a demultiplexer, and is output at different angles for each wavelength by the diffraction grating. The output ports of the AWG 215 of FIG. 14 correspond to the emission angles. The emission angles are adjusted according to the wavelength to be detected.

The separator 21 may be configured using a waveguide-type ring resonator. For example, a micro ring resonator (MRR) having a resonator length of several 10 micrometers and a resonant wavelength interval (free spectral range (FSR) ) of several 10 nm may be used. As the shape of the ring resonator portion, a racetrack shape in which the coupling portion is a parallel straight waveguide may be used instead of a perfect circular shape. With such a configuration, the coupling coefficient at the coupling portion can be easily designed.

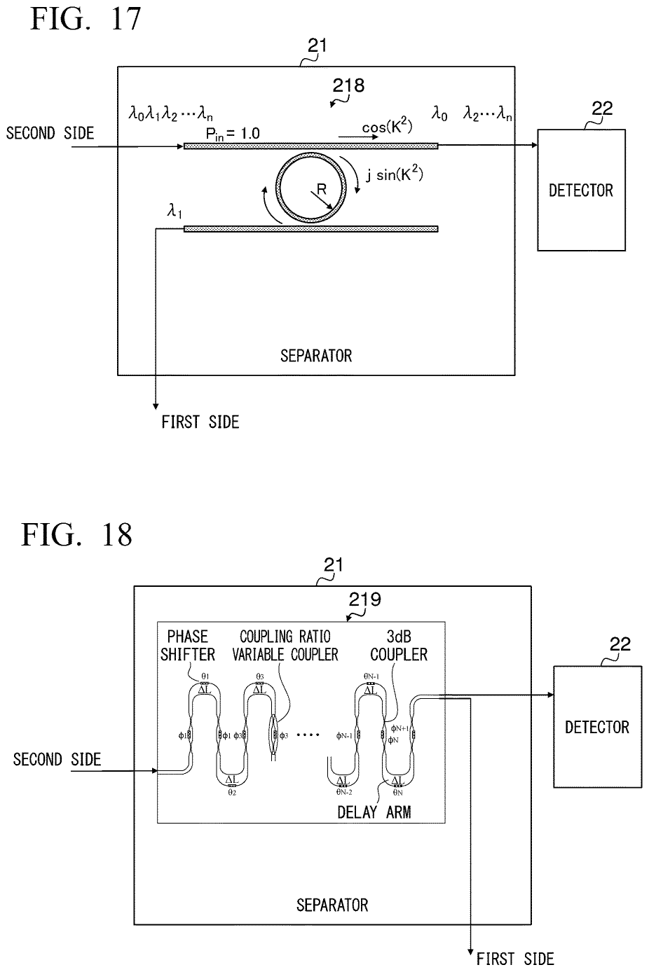

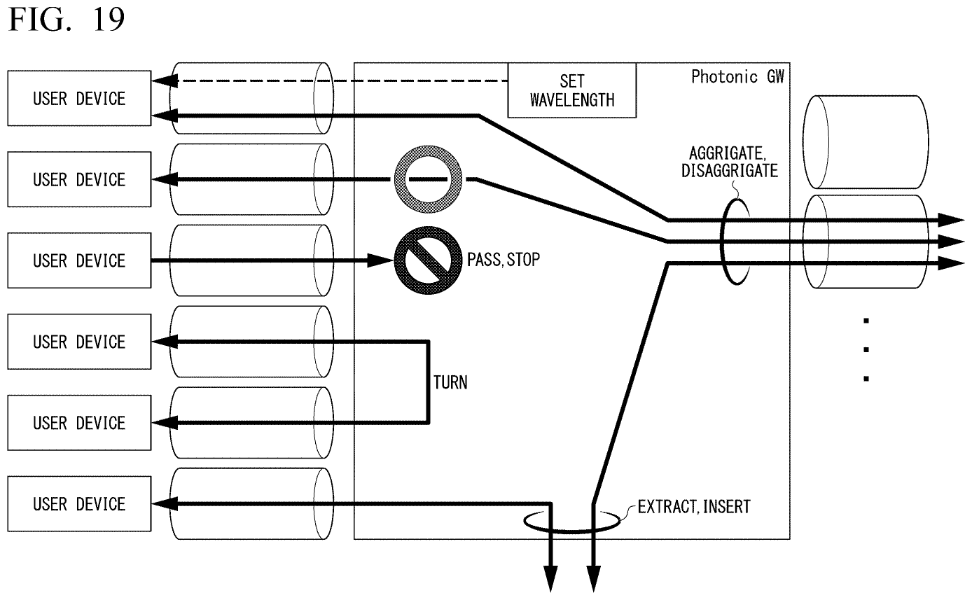

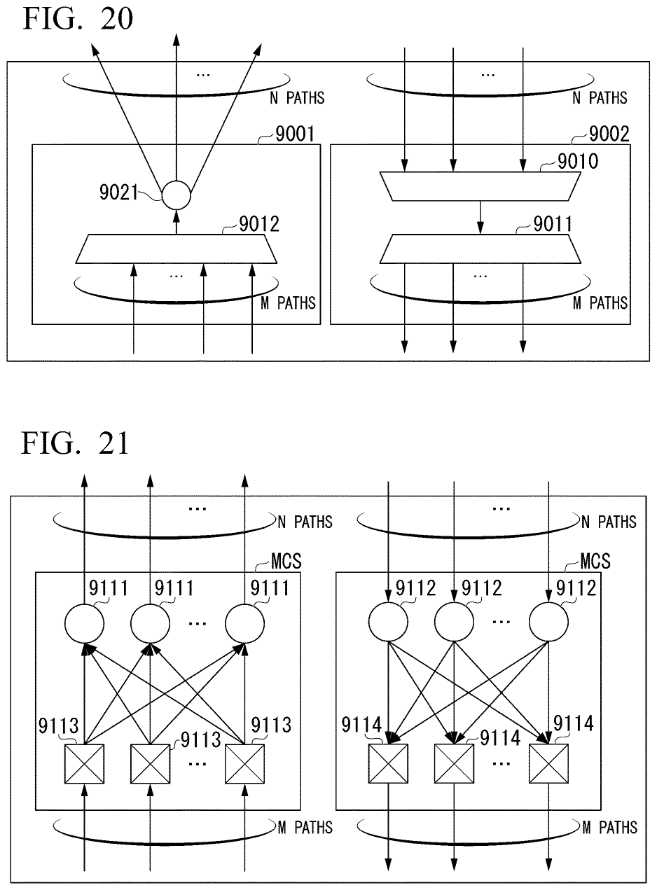

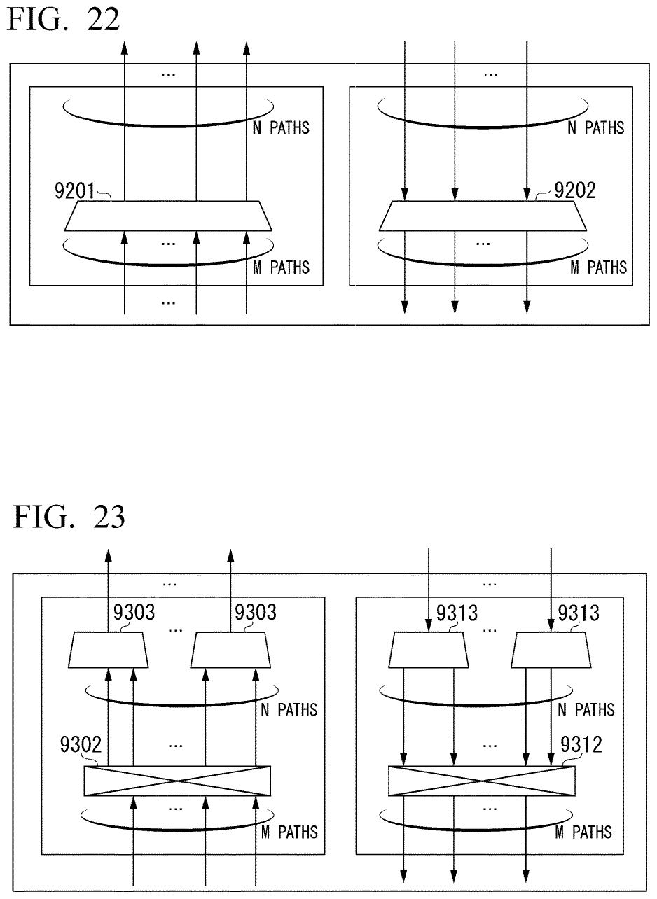

Series coupling may be applied to the waveguide-type ring resonator. In the series coupling, a plurality of rings is included. In the following description, an example of a waveguide-type ring resonator using one ring will be described in the specific example of FIG. 17. Note that a plurality of rings may be used in the example illustrated in FIG. 17. With such a configuration, it is possible to obtain spectral characteristics in which the transmission band is flat, the transition (roll-off) from the transmission band to the blocking band is steep, and the blocking amount is sufficient. However, a coupling coefficient between a bus line waveguide and a microring and a coupling coefficient between one microring and another microring satisfy a certain condition said to be a Butterworth condition. As a specific example of series coupling for increasing a Q factor that is a degree of resonance while widening a pass band (width of a selected wavelength), for example, there is a double ring.

FIG. 17 is a diagram illustrating a configuration example in which the separator 21 is configured using a waveguide-type ring resonator. The separator 21 includes a waveguide-type ring resonator 218. The waveguide-type ring resonator 218 receives an optical signal received from the second side from an upper left port, and outputs a desired separation signal and a residual separation signal from different ports.

The separator 21 may be configured using a lattice-type optical filter. The lattice-type optical filter includes, for example, a delay line, a symmetric Mach-Zehnder interferometer type coupling ratio variable coupler, and a phase adjustor. By changing the phase shift value of the optical filter, any filter characteristic whose upper limit is performance determined by the number of asymmetric Mach-Zehnder interferometers can be obtained. A property that a characteristic periodically appears for each free spectral range (FSR) determined by AL is used.

In the lattice type, a path length difference of each asymmetric MZI constituting the lattice is AL. In the transversal type, a length of a delay applier between the branches is AL. In an AWG, a difference in length between one waveguide constituting an array waveguide and an adjacent waveguide is AL.

In a case where the period is short, similarly to the periodic AWG, it may be implemented by combining a plurality of filters. In order to eliminate the polarization dependence, a circulator and a Faraday rotating mirror having a rotation angle of 90 degrees may be installed at the input and output ends, respectively, to implement a reflection type configuration. In FIG. 17, the combination of a ring waveguide of the waveguide-type ring resonator 218 and two linear waveguides corresponds to a demultiplexer. The wavelength to be detected is adjusted by changing a ring diameter R and coupling between the ring waveguide and the linear waveguides.

FIG. 18 is a diagram illustrating a configuration example in which the separator 21 is configured using the lattice-type optical filter. The separator 21 includes a lattice-type optical filter 219. The lattice-type optical filter 219 receives an optical signal received from the second side, and outputs a desired separation signal and a residual separation signal from different ports.

Specifically, the lattice-type optical filter 219 outputs the desired separation signal from the first port to the first side, and outputs the residual separation signal from the second port to the detector 22. The delay AL of the delay arm of the lattice filter, the coupling ratio of the coupling ratio variable coupler, and the phase O of the phase shifter are adjusted such that the first port outputs a proper wavelength component and the second port outputs an improper wavelength component. In addition, in the case of the lattice, the coupling ratio between the delay AL of the delay applier and the tap (coupling ratio variable coupler) and the phase of the phase shifter may be adjusted. In FIG. 18, the lattice-type optical filter 219 in which a Mach-Zehnder interferometer is cascade-connected corresponds to a demultiplexer. The wavelength to be detected is changed by adjusting the coupling ratio between the phase shifter and the coupler.

Although the embodiments of the present invention have been described in detail with reference to the drawings, specific configurations are not limited to the embodiments and include design and the like within the gist of the present invention.

### INDUSTRIAL APPLICABILITY

The present invention is applicable to a communication system that performs communication through an optical fiber transmission line.

### REFERENCE SIGNS LIST

30-1, 30-2, 30-2, 30-4, 30-5, 30-6, 30-7, 30-8 . . . Ph-GW
400, 1400, 2400, 3400, 5400, 6400, 7400 . . . Blocking controller
410, 1410, 2410, 3410, 5410, 6410, 7410, . . . SA

1. A communication system comprising:
an acquirer that acquires a wavelength set to a user terminal;
an optical cross-connect that outputs an optical signal to at least one output destination of a plurality of output destinations;
an observer that observes a wavelength of a signal input from a user terminal to the optical cross-connect or a wavelength of a signal output from the optical cross-connect to a user terminal; and
a blocker that blocks input from the user terminal or output to a user terminal, or blocks a wavelength component different from an acquired wavelength, in a case where a wavelength observed by the observer is different from a wavelength acquired by the acquirer.

2. The communication system according to claim 1 comprising a splitting device that splits a signal input from a user terminal to the optical cross-connect or a signal output from the optical cross-connect to a user terminal to an observer,
wherein the observer receives as input a signal split from the splitting device in a time division manner for each user terminal.

3. The communication system according to claim 1 comprising another optical cross-connect that outputs a signal input from a user terminal to the optical cross-connect or a signal output from the optical cross-connect to a user terminal to an observer,
wherein the observer receives as input a signal output from the another optical cross-connect in a time division manner for each user terminal.

4. The communication system according to claim 1,
wherein the observer includes a demultiplexer that demultiplexes an input signal, and a detector that detects a signal output by a demultiplexer.

5. The communication system according to claim 1,
wherein in a case where a wavelength observed by the observer is different from a wavelength acquired by the acquirer, the blocker causes the optical cross-connect to block a signal determined to have a different wavelength.

6. The communication system according to claim 1,
wherein in a case where a wavelength observed by the observer is different from a wavelength acquired by the acquirer, the blocker causes a wavelength filter to block a wavelength component of a wavelength determined to be a different wavelength.

7. A control method of a communication system including an optical cross-connect that outputs an optical signal to at least one output destination of a plurality of output destinations, the control method comprising:
acquiring a wavelength set to a user terminal;
observing a wavelength of a signal output from a user terminal to the optical cross-connect or a wavelength of a signal output from the optical cross-connect to a user terminal; and
blocking input from the user terminal or output to a user terminal, or blocking a wavelength component different from an acquired wavelength, in a case where a wavelength observed is different from a wavelength acquired.

8. The communication system according to claim 2,
wherein in a case where a wavelength observed by the observer is different from a wavelength acquired by the acquirer, the blocker causes the optical cross-connect to block a signal determined to have a different wavelength.

9. The communication system according to claim 3,
wherein in a case where a wavelength observed by the observer is different from a wavelength acquired by the acquirer, the blocker causes the optical cross-connect to block a signal determined to have a different wavelength.

10. The communication system according to claim 2,
wherein in a case where a wavelength observed by the observer is different from a wavelength acquired by the acquirer, the blocker causes a wavelength filter to block a wavelength component of a wavelength determined to be a different wavelength.

11. The communication system according to claim 3,
wherein in a case where a wavelength observed by the observer is different from a wavelength acquired by the acquirer, the blocker causes a wavelength filter to block a wavelength component of a wavelength determined to be a different wavelength.
